(19) United States
(12) Patent Application Publication
(10) Pub. No.: US 2017/0080317 A1
(43) Pub. Date: Mar. 23, 2017

(54) CATCH AND THROW BALL TRAINING DEVICE

(71) Applicant: Jose Luis MATUTE SALGADO, CALGARY (CA)

(72) Inventor: Jose Luis MATUTE SALGADO, CALGARY (CA)

(21) Appl. No.: 15/367,892

(22) Filed: Dec. 2, 2016

Related U.S. Application Data
(62) Division of application No. 14/750,628, filed on Jun. 25, 2015.

(51) Int. Cl. A63B 69/00; C09J 5/00

(52) U.S. Cl. CPC A63B 69/0079; A63B 69/0086; C09J 5/00; A63B 2102/14

(57) ABSTRACT

A ball training device having an elongated elastic tether, a ball connected to one end of the tether and a means for attachment the device to the wrist of a user, or to a lacrosse stick, at the other end of the tether. A holder that comprises a co-ordinating plurality of straps that are affixed to the ball is used to attach the ball to the tether. The device is used to practice ball handling skills for catch and throw sports such as baseball, softball, lacrosse and cricket.

### FIELD

A device that enables a person to practice ball handling catch and throw techniques by themselves.

### BACKGROUND

Tethered balls for use as toys or as practice devices exist. U.S. Pat. No. 5,094,462 teaches a tethered soccer ball wherein the ball is in a net, the net is attached to one end of a bungee cord and the other end of a bungee cord is attached to a strap that wraps around a person's wrist or ankle.

U.S. Pat. No. 6,971,963 teaches a toy with a springable cord and a ball. The toy has a wrist band that is stated to provide a way for minimizing twisting and knotting of the elastic band in the device. CA Patent 2,105,948 teaches an athletic training device in which a ball is secured to the end of an extensible elastic cord and the other end is attached to a lacrosse stick or to a player's wrist. U.S. Pat. No. 5,083,797 teaches a game ball training apparatus/carrier that has a net for retrieving or holding the ball and an adjustable inelastic tether cord or rope connecting the user to the ball. U.S. Pat. No. 8,257,203 teaches a volleyball training system in which the ball is connected to the user's body so that once hit, the ball will not travel far from the user and can be easily retrieved.

U.S. Pat. Nos. 2,142,068, 2,269,633, 3,031,191, 3,042,404, 3,351,343, 3,635,476, 3,843,126, 4,147,353, 4,350,338, 4,601,474 and 4,836,555 describe various other tethered ball game toys and training devices.

There is a need in the art for a device that can be used to practice ball handling skills for throw and catch sports, and which mimics the real game situation. The device should enable a person to throw and catch a ball alone, without the need for a partner, or a wall or other structure to return the ball. The device should be durable and easy to manufacture.

### SUMMARY

Described herein is a ball training device that is designed to aid users in developing ball-handling skills of many and varying types, such as catching and throwing techniques, hand-eye coordination, reaction time, accuracy, speed and footwork, without having to retrieve the ball. The ball training device comprises a ball, an elastic tether and an means of attaching the device to a user or to a lacrosse stick.

In one aspect, described herein is ball training device comprising an elongated elastic tether made of round shock cord, having a first end and a second end,
a) a ball connected to the first end of the tether, the ball being enclosed by a holder that comprises a plurality of straps that are affixed to the ball, the plurality of straps comprising at least two longitudinal straps, each longitudinal strap encircling the ball from a top apex to a bottom apex, said at least two straps overlapping at the top apex and at the bottom apex;
b) the first end of the tether being inserted under the overlapping at least two longitudinal straps at the top apex of the ball; and
c) an attachment means connected to the second end of the tether, for attachment of the second end of the tether to the wrist of a user, or to a lacrosse stick.

The holder may further comprise at least one transverse strap encircling the ball transverse to the longitudinal straps. In one embodiment the holder has one transverse strap that is affixed to the ball midway between the top apex and the bottom apex of the ball.

In one embodiment the plurality of straps is affixed to the ball by using glue. In one embodiment the first end of the tether and/or the second end of the tether are tied to the tether by a self-tightening knot.

In one embodiment the longitudinal and transverse straps are made of a flat woven elastic. In one embodiment the attachment means is a wrist strap. In one embodiment the attachment means is an elastic element sized to attach to a lacrosse stick. In one embodiment the ball is a practice baseball or practice softball.

In another aspect, described herein is a method of making a ball training device comprising the steps of:
a) preparing at least two circular longitudinal elastic straps, each strap having a diameter such that it needs to be stretched to encircle a ball;
b) positioning a first strap of said at least two longitudinal straps on the ball by stretching it around the ball between a top and a bottom apex;
c) affixing the first strap to the ball;
d) positioning a second strap of said at least two longitudinal straps on the ball by stretching it around the ball between a top and a bottom apex;
e) affixing the second strap to the ball;
f) inserting a first end of an elongated elastic tether made of round shock cord underneath the at least two longitudinal straps at the top apex, and tying that first end of the tether to the tether itself.

The method may further comprises the steps of:
a) preparing at least one transverse circular elastic strap, having a diameter such that it needs to be stretched to encircle the ball;
b) positioning the at least one transverse elastic strap on the ball by stretching it around the ball and over said at least two circular longitudinal elastic straps at a right angle thereto; and
c) affixing the at least one transverse elastic strap to the ball.

In one embodiment, the at least two circular longitudinal elastic straps are made of woven elastic. In one embodiment the at least one transverse longitudinal elastic strap is made of woven elastic. In one embodiment the affixing is by gluing, and in one embodiment the glue is a hot melt adhesive. In one embodiment the ball is a practice baseball or a practice softball.

### BRIEF DESCRIPTION OF THE DRAWINGS

FIGS. 1A and 1B show an embodiment of the ball training device wherein the tether is attached to a user's wrist. FIG. 1A shows a top perspective view of the ball in its holder attached to the tether, and the wrist strap; FIG. 1B shows a bottom perspective view of the ball in its holder.

FIG. 2 is perspective view of an embodiment of the ball training device wherein the tether is attached to a lacrosse stick.

### DETAILED DESCRIPTION

The ball training device 10 comprises a ball 12, a tether 14 and attachment means 16 for attaching the device to the wrist of a user or to a lacrosse stick.

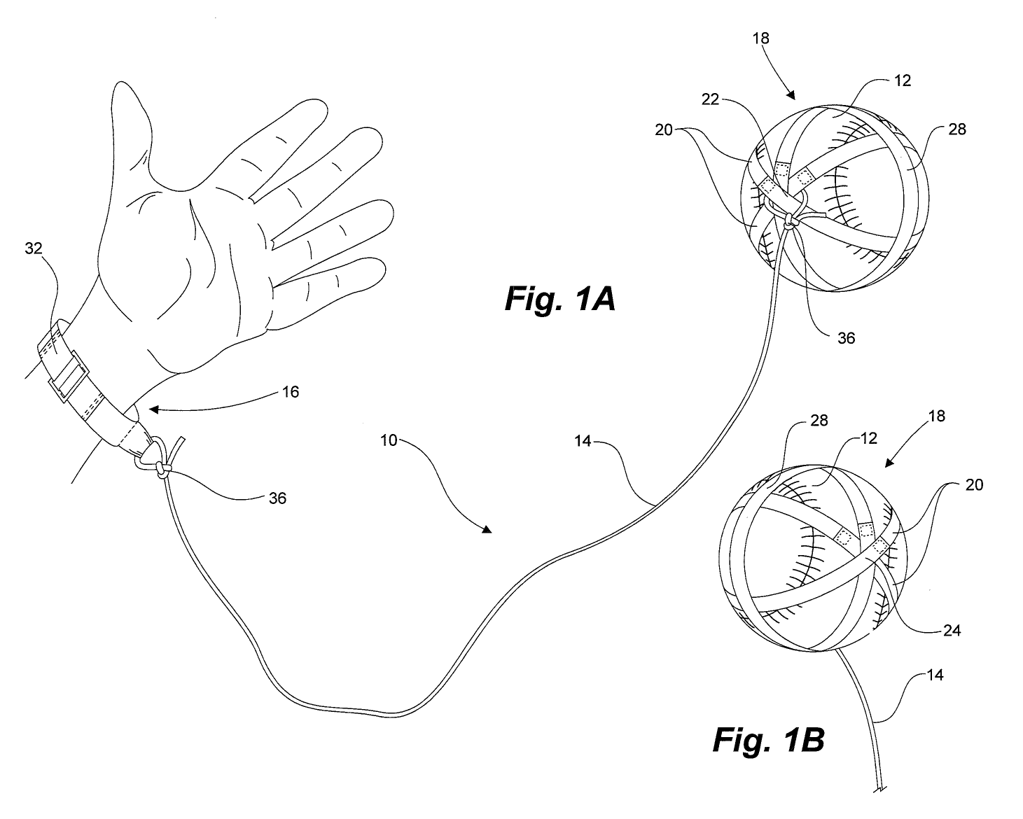

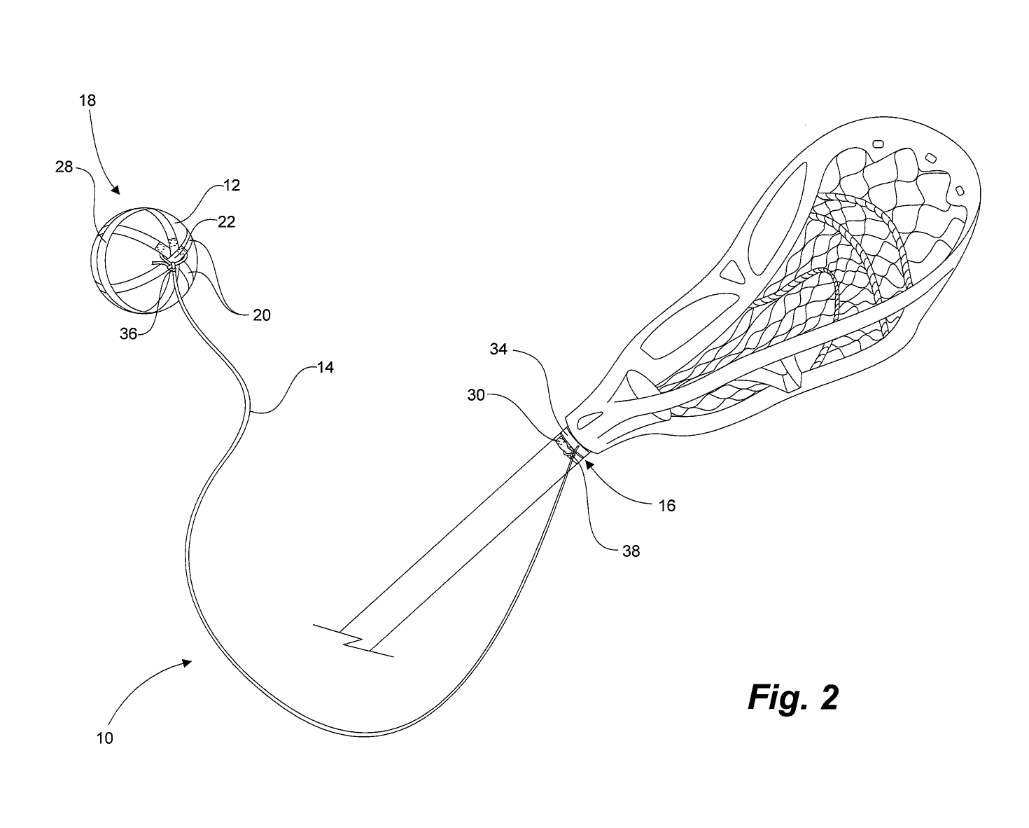

More particularly, and as shown in the accompanying FIGS. 1 and 2 the device comprises an elongated tether 14 having one end attached to the ball 12 and the other end attached to the attachment means 16. In FIG. 1, the attachment means is a wrist strap and in FIG. 2 the attachment means is an elastic loop. The device avoids the use of metal clips or attachments at any point, being easy to manufacture and use.

The ball 12 is spherical, and is any type of ball which may be used in a catch-and-throw sport, such as a baseball, softball, lacrosse ball or cricket ball. The lacrosse and cricket ball used in the device is a standard game ball. However, the baseball or softball used in the device is a training ball as opposed to a ball that would be used in a game. Training balls are softer than a standard ball used during a game, which reduces the chance of injury during a training session. Because they are softer, they are typically more bouncy, leading to a better training experience.

Typically the baseball has about a 9 inch circumference if a baseball training ball, and a 12, 11 or 10 inch circumference if a softball training ball. Preferred as the baseball training ball is an Easton® 9″ practice ball which has raised seams, a high density foam core and a synthetic cover. Preferred as the softball training ball is a Protac® 11″ NC11S NCAA indoor/outdoor practice ball which has raised seams and a soft poly core.

The device described herein has a harness-type holder 18 which encompasses and confines the ball 12. The holder 18 comprises a plurality of co-ordinating straps which are affixed to the ball's surfaces, for example with glue. The co-ordinating straps are broad and thin, and have a minimal impact on the original shape of the ball. Because the ball does not slip in the holder, and because the holder 18 minimally impacts shape, practicing with the ball provides a realistic real-game experience.

At least two of the co-ordinating straps are longitudinal straps 20 that encircle the ball, overlapping at the top 22 and bottom 24 apex of the ball. The at least two longitudinal straps therefore cross over one another at the top and bottom apex of the ball, and are otherwise equally and/or maximally spaced from one another (i.e., distributed evenly around the ball).

The straps are affixed, as by glue, to the ball along almost all of their entire lengths. At the top apex 22 the straps overlap with one another but they are not affixed to the ball, therefore providing a space between themselves and the ball. This space allows for insertion of one end of the tether 14 therethrough, in order to attach the tether to the ball. In a preferred embodiments, three longitudinal straps 20 are used, as shown in FIGS. 1A, 1B and 2 herein. Because the straps are affixed to the ball, they do not stretch as the ball is repeatedly thrown and caught, thereby increasing the durability of the device.

In some embodiments the holder 18 may additionally have at least one transverse strap 28 wrapped around the ball transverse to the longitudinal straps (that is, at a right angle to the longitudinal straps). The at least one transverse strap is affixed to the ball, as by gluing, and also optionally to the longitudinal straps where it overlaps these straps. In a preferred embodiment shown in FIGS. 1 and 2, the at least one transverse trap is glued to the ball and to the longitudinal straps about midway between the top and bottom apexes of the ball. In some embodiments two or more transverse straps 28 may be used.

In a preferred embodiment the longitudinal and transverse straps are made from a flat elastic, such as a braided, woven or knit elastic, made with polyester, nylon or other material. In one embodiment the elastic is B5-⅜″ woven elastic, available for example from PanCana Enterprises Ltd. Before attachment to the ball, the elastic is cut to size and the ends are overlapped and stitched together as at 30. The straps are sized so that they need to be stretched to encircle the ball. The straps are then stretched and positioned around the ball, thus they are thinner when positioned on the ball than they are in their un-expanded state.

The straps may be affixed to the ball, for example by gluing them to the ball. In an alternative embodiment the holder may be affixed to the ball by stitching it to the ball. A particularly preferred means of affixing the ball to the holder is to use a glue, such as a hot melt adhesive. This type of glue is commonly supplied in solid cylindrical sticks of various diameters, designed to be melted in an electric hot glue gun. The melted glue may be pushed through the gun by a mechanical trigger mechanism, or directly by the user. Hot melt adhesives can also be applied by dipping or spraying. Applicant has found that hot melt adhesives are particularly useful in enhancing the durability of the training device described herein, avoiding separation of the ball from the holder with repeated use as compared to other types of glues. The glue may be used along the entire length of the longitudinal straps, except at the top apex, and along the entire length of the transverse straps, or it may be applied only at sections of these straps. One hot melt glue useful herein is Ad Tech Pro Strength™ glue, available from Adhesive Technologies, Inc.

The ball 12 may be affixed to the holder 18, by preparing at least two circular elastic longitudinal straps that have a diameter such that they need to be stretched to encircle the ball. The first longitudinal strap is positioned on the ball by stretching it around the ball, and is affixed to the ball for example by gluing it to the ball with hot glue. A top apex of the strap, where the tether is to be attached, is not glued to the ball. The second longitudinal strap is then positioned on the ball by stretching it around the ball, and affixing it to the ball (except at the top apex), and optionally to the other longitudinal strap where there is overlap. This process may be repeated with a third or subsequent longitudinal strap.

If one or more transverse straps 28 is used, a circular elastic strap that has a diameter such that it needs to be stretched to encircle the ball is prepared. This strap is positioned on the ball by stretching it around the ball over the longitudinal straps, and is affixed to the ball by gluing it to the ball and optionally to the longitudinal straps where it overlaps these straps. This process may be repeated with a second or subsequent transverse strap.

Ball 12 is attached to one end of the tether 14 at the top apex 22 of the ball. A single point of attachment minimally interferes with the user's ability to grasp, throw and otherwise handle the ball and maintains the ball in a state of balance and equilibrium so that the ball performs as much as possible as though it were free of the holder, providing a realistic real-game experience.

As shown in the drawings herein, tether 14 is attached to the ball by slipping the end of the tether underneath all of the overlapping longitudinal straps at the apex and tying the end back to tether itself with a knot 36. The knot used is a self-tightening knot, for example an Arbour knot or a Noose knot. Self-tightening knots tighten when pulled, therefore each time the ball is thrown and the tether is expanded beyond its resting length, the knot can tighten. In this way, even though the ball is attached to the tether via a knot, it does not become detached by repeated use of the device, but rather becomes even more firmly attached. This type of attachment is simple, yet very effective.

In the device herein the attachment point of the ball to the tether is soft and malleable, avoiding the use of hard components such as metal buckles or clasps that injure the users hand upon repeated contact therewith.

The tether 14 is an elongated and expandable elastic line or cord that provides the retrieving and rebounding effect needed in the instant device. The use of an elastic tether is advantageous because it provides recoil force to propel a ball towards the user, to simulate a ball that has been thrown to or batted at the user. In device 10, the tether is round shock cord (also known as stretchy paracord, bungee rope/cord, shock rope, elasticated rope/cord). More particularly, the tether is an elastic cord composed of one or more elastic strands forming a core, covered in a woven sheath (usually nylon or polyester). The sheath does not extend elastically to any significant extent, but is braided around the core so that a longitudinal pull causes it to squeeze the elastic core, transmitting the core's elastic compression to the longitudinal extension of the sheath and cord.

The shock cord has the extensibility, resilience, and tensile strength needed such that at the selected length, the throwing and catching of the ball will have the characteristics or rebound desired by the end user. Preferred for use herein is H2- 3/32″ round shock cord. In other embodiments the shock cord may be H2-⅛″ round shock cord.

The length of the tether will vary, depending upon the intended user (children or adults) and their level of skill (inexperienced or experienced).

The means 16 for attachment of the device to a wrist of a user may be a wrist band 32, as shown in FIG. 1. The wrist band secures around the wrist of the user and may be, as a non-limiting example, a cloth (such as nylon) strap that is fastened by mating Velcro™ surfaces on either end that enable the wrist band to be easily secured, adjusted for tightness to, and released from the user's wrist. Snaps, buttons or other adjustment or fastening means may be used. In use, the wrist band may be secured about the wrist of the throwing hand or the catching hand.

For attachment to a lacrosse stick, as shown in FIG. 2, the device comprises an elastic element 34 that securely fits around the shaft of the stick and is brought up the shaft until it is adjacent with the throat. The elastic element is circular and expandable so that the end of tether can be removed from the shaft, to allow the user to use the lacrosse stick in a game. In one embodiment the elastic is cut to size and the ends are overlapped and stitched together as at 30.

As shown in the Figs. herein, tether 14 is attached to the attachment means by wrapping an end of the tether around the attachment means or part thereof (e.g., a loop in the wrist band) and then and tying the end of the tether back to the tether itself to form a knot 38. The type of knot used is, again, a self-tightening knot.

The length of the tether can be varied depending on the types of skills that the end user is trying to develop, and on the type of game that they are practicing for. For a ball training device used to practice baseball, two different exemplary embodiments are described herein, one with a long tether and one with a short tether.

The long tether embodiment is used when practicing skills related to retrieving a ball that has bounced off of the ground, and to practice different catching styles (i.e., forehand, backhand, running, etc.). Thus, after it is thrown, the ball attached to the long tether will impact the ground and bounce one or more times before it is caught by the user. For this purpose a practice baseball is used, as it is bouncier than a game ball and is therefore better for practicing ball retrieval skills from a ground return. In one embodiment the long tether is an H2- 3/32″ shock cord, with a length of about 5.5 ft., from the attachment means 16 (wrist strap) to the ball 12, which is a practice ball. In this embodiment, the holder may comprise three longitudinal straps 20 and one transverse strap 28, made of B5-⅜″ woven elastic (see e.g., FIGS. 1A, 1B and 2).

On the other hand, the short tether provides a faster rebound and it is designed so that after it is thrown, rather than hitting the ground it remains in air and returns to the user's hand. It can also be thrown to the ground to simulate a bouncing ball. In one embodiment the tether is an H2- 3/32″ shock cord, with a length of about 3.5 ft., from the attachment means 16 (wrist strap) to the ball 12. In this embodiment, the holder may again comprise three longitudinal straps 20 and one transverse strap 28, made of B5-⅜″ woven elastic, as shown in FIGS. 1A and 1B herein.

A ball training device used to practice softball is designed to be used to practice underarm pitching and also to allow the ball to bounce of the ground, and therefore to be useful to work on ground returns. Again, a practice ball is used in this device as it is bouncier than a game ball. In one embodiment the tether is an H2- 3/32″ shock cord with a length of about 5 ft., from the attachment means 16 (wrist strap) to the ball. In this embodiment, the holder may comprise three longitudinal straps 20 and one transverse strap 28, made of B5-⅜″ woven elastic (see e.g., FIGS. 1A, 1B and 2).

A ball training device used to practice lacrosse is designed to be attached to the stick at the throat. In one embodiment the tether is an H2- 3/32″ shock cord, with a length of about 6.5 ft., from the attachment means 16 (elastic element) to the ball. In this embodiment, the holder may comprise three longitudinal straps 20 and one transverse strap 28, made of B5-⅜″ woven elastic (see e.g., FIGS. 1A, 1B and 2).

The use of the ball training device for practicing baseball or softball will now be described. The wrist strap may be affixed to the wrist of the user's throwing hand, and a glove may be put on the other hand. The user will then throw the ball in one of many different directions—straight ahead, upwards, downwards, and sideways—and even be directed to the ground, or for softball, an underhand pitch. The force of the throw will cause the ball to stretch the tether until it is elastically stressed enough to counteract the force of the ball, at which point the ball returns back to the user, often in the immediate vicinity of the user. The user may have to reposition their hand or their feet, and may have to adjust body position in order to catch the ball. This cycle can be repeated, enabling the user to enhance their reflexes, hand-eye-foot coordination, and otherwise improve the skills needed to play baseball or softball.

While the ball training device has been described in conjunction with the disclosed embodiments and examples which are set forth in detail, it should be understood that this is by illustration only. The scope of the claims should not be limited to the preferred embodiments but should be given the broadest interpretation consistent with the description as a whole.

1. A method of making a ball training device comprising:
a) stretching a first circular elastic strap around an outside surface of a ball between a top apex and a bottom apex of the ball;
b) stretching a second circular elastic strap around the outside surface of the ball between the top apex and the bottom apex of the ball, such that the second elastic strap overlaps the first elastic strap at the top apex and at the bottom apex;
c) gluing the first elastic strap and the second elastic strap to the outside surface of the ball; and
d) inserting a first end of an elongated elastic tether underneath the first and second elastic straps at the top apex, and tying the first end of the tether to the tether itself

2. The method of claim 1 further comprising:
a) stretching a third circular elastic strap around the outside surface of a ball between the top apex and the bottom apex of the ball,
b) gluing the third elastic strap to the outside surface of the ball, and
c) inserting the first end of the elongated elastic tether under the first, second and third elastic straps at the top apex.

3. The method of claim 1 further comprising:
a) stretching a transverse circular elastic strap around the outside surface of the ball at a right angle to the first and second elastic straps; and
b) gluing the transverse elastic strap to the outside surface of the ball.

4. The method of claim 2 further comprising:
c) stretching a transverse circular elastic strap around the outside surface of the ball at a right angle to the first, second and third elastic straps; and
d) gluing the transverse elastic strap to the outside surface of the ball.

5. The method of claim 3 wherein the transverse elastic strap is positioned midway between the top apex and the bottom apex of the ball.

6. The method of claim 4 wherein the transverse elastic strap is positioned midway between the top apex and the bottom apex of the ball.

7. The method of claim 1 wherein the first and second elastic straps are made of woven elastic.

8. The method of claim 2 wherein the third elastic strap is made of woven elastic.

9. The method of claim 3 wherein the transverse elastic strap is made of woven elastic.

10. The method of claim 4 wherein the transverse elastic strap is made of woven elastic

11. The method of claim 2 further comprising:
a) stretching at least one additional circular elastic strap around the outside surface of a ball between the top apex and the bottom apex of the ball;
b) gluing the at least one additional strap to the outside surface of the ball, and
c) inserting the first end of the elongated elastic tether under the at least one additional elastic strap at the top apex.

12. The method of claim 3 further comprising:
a) stretching at least one additional transverse circular elastic strap around the outside surface of the ball at a right angle to the first and second elastic straps; and
b) gluing the at least one additional transverse elastic strap to the outside surface of the ball.

13. The method of claim 4 further comprising:
a) stretching at least one additional transverse circular elastic strap around the outside surface of the ball at a right angle to the first and second elastic straps; and
b) gluing the at least one additional transverse elastic strap to the outside surface of the ball.
